(19) United States
(12) Patent Application Publication
(10) Pub. No.: US 2010/0297473 A1
(43) Pub. Date: Nov. 25, 2010

(54) FUNCTIONAL FILM, METHOD FOR MANUFACTURING FUNCTIONAL FILM, AND APPARATUS FOR MANUFACTURING FUNCTIONAL FILM

(75) Inventors: Eijirou Iwase, Kanagawa (JP); Jun Fujinawa, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/782,204

(22) Filed: May 18, 2010

(30) Foreign Application Priority Data
May 20, 2009 (JP) 2009-122136

(51) Int. Cl. B32B 9/00; B05D 1/36; B05C 13/00

(52) U.S. Cl. 428/688; 427/172; 118/33

(57) ABSTRACT

A method for manufacturing a functional film, includes the steps of: continuously feeding a support from a first film roll, forming, on the support, a coating film having a degree of hardness of 3B or more, and winding up the support into a second film roll at a tension of 30 N/m or more; and loading the second film roll which has been wound up in the prior step in a vacuum film forming apparatus, continuously feeding the support from the second film roll, forming an inorganic film on the coating film formed on the support, and winding up the support into a third film roll.

### CROSS-REFERENCE TO RELATED APPLICATIONS

This application claims the priority benefit under 35 U.S.C. §119 of Japanese Patent Application No. 2009-122136 filed on May 20, 2009, which is hereby incorporated in its entirety by reference.

### BACKGROUND OF THE INVENTION

1. Field of the Invention

The presently disclosed subject matter relates to a functional film, a method for manufacturing the functional film, and an apparatus for manufacturing the functional film, and more specifically, to a functional film including a laminated structure, in which an inorganic film is formed on a coating film that has been formed while feeding a film roll obtained by winding the formed coating film; a method for manufacturing the functional film, and an apparatus for manufacturing the functional film.

2. Description of the Related Art

Functional films such as gas barrier films, protective films, optical filters, and anti-reflection films are used in a variety of devices, for example, optical elements, display apparatuses such as liquid crystal display apparatuses, and organic EL (electroluminescence) display apparatuses; semiconductor apparatuses; and thin-film solar cells.

Meanwhile, for manufacturing these functional films, film formation techniques through vacuum film forming methods such as sputtering, and plasma CVD (chemical vapor deposition) method are used. In order to efficiently form a film by a vacuum film forming method while achieving high productivity, it is carried out to continuously form a film on a lengthy base material.

The following describes one method for manufacturing the above-mentioned functional film. A lengthy support is continuously fed from a film roll. Then, a coating liquid is applied onto the support, dried, and cured to form a coating film. The support having the coating film formed thereon is wound up to form a film roll. Next, the film roll having the coating film formed thereon is set in a feeding unit of a vacuum film forming apparatus, and the support is continuously fed from the film roll to a film formation chamber. Then, in the film formation chamber, an inorganic film is formed on the coating film to form a film having a laminated structure composed of the coating film and the inorganic film, and the film having a laminated structure is wound up, thereby manufacturing a film roll. As equipment for carrying out such a film forming method, a so-called roll-to-roll film forming apparatus is known. By repeating the step of forming a coating film and an inorganic film plural times by the film forming apparatus, it is possible to manufacture a functional film having a plurality of laminated structures formed.

In the above manufacturing method, in order to prevent winding faults during film formation of an inorganic film (rub between the inorganic film formed on a support caused by winding the support) and to maintain uniform quality of a functional film, Japanese Patent Application Laid-Open No. 08-92727 discloses a method in which a film roll having a winding hardness (hardness of the film roll) of 70 to 95 is set in a feeding unit of a vacuum film forming apparatus, and an inorganic film is continuously formed on a support.

### SUMMARY OF THE INVENTION

However, even if a film roll having a coating film formed thereon is wound with a winding hardness of 70 to 95 as described in Japanese Patent Application Laid-Open No. 08-92727, the film roll unfavorably picks up entrained air when the support is wound up. When an air-entrained film roll is set in a feeding unit in a vacuum film forming apparatus, the pressure around the feeding unit being reduced; the entrained air in the film roll comes out of the film roll. Thus, the balance of stress (tension, frictional force) inside the film roll is disrupted while the stress is balanced during winding the film. The film roll tends to cause “tight winding” (shrinkage of roll diameter).

The inventors of the presently disclosed subject matter have found that if a film roll causes the “tight winding”, in the film roll, a coating film formed on a support comes into contact with a back surface of the support which is thereabove, and microscopic film rupture occurs in the coating film, resulting in loss of smoothness of the film.

Subsequently, when the support is conveyed and an inorganic film is formed on the coating film, a film-forming fault occurs to cause cracks and peel-off of the inorganic film.

The presently disclosed subject matter has been made in light of the circumstances, and an object of the presently disclosed subject matter is to provide a functional film, a method for manufacturing the functional film and an apparatus for manufacturing the functional film capable of reducing the occurrence of faults such as cracks and peel-off of an inorganic film when the inorganic film is formed on a coating film by a vacuum film forming method.

To achieve the above-mentioned object, the presently disclosed subject matter provides a method for manufacturing a functional film includes the steps of: continuously feeding a support from a first film roll, forming, on the support, a coating film having a degree of hardness of 3B or more, and winding up the support into a second film roll at a tension of 30 N/m or more; and loading the second film roll which has been wound up in the prior step in a vacuum film forming apparatus, continuously feeding the support from the second film roll, forming an inorganic film on the coating film formed on the support, and winding up the support into a third film roll. Here, the hardness is represented by the pencil hardness defined by the Japanese Industrial Standards, no. JIS S 6006.

According to the presently disclosed subject matter, even when the second film roll which is obtained by coating, drying and curing a coating film having a degree of hardness of 3B or more and then winding at a tension of 30 N/m or more is set in a vacuum film forming apparatus, the coating film will not suffer damage, and thus it is possible to provide a method for manufacturing a functional film capable of reducing the occurrence of faults such as cracks and peel-off of a coating film and an inorganic film.

Note that the degree of hardness of the coating film is more preferably 3B to 3H and the tension at which the coating film is wound up on the second film roll is more preferably 30 N/m to 500 N/m.

In the method for manufacturing a functional film of the presently disclosed subject matter, in order to wind up the support having the coating film formed thereon into the second film roll, it is preferably to wind up the support using a lay-on roller.

By using a lay-on roller, it is possible to reduce entrained air from getting inside the second film roll during winding, and thus even when the second film roll of the support having the coating film formed thereon is loaded in the vacuum film forming apparatus, it is possible to reduce the occurrence of tight winding.

Further, in the method for manufacturing a functional film of the presently disclosed subject matter, the thickness of the inorganic film formed is preferably 10 nm or more. Note that, the thickness of the inorganic film is more preferably 10 nm to 200 nm.

Further, in the method for manufacturing a functional film of the presently disclosed subject matter, the coating film is preferably formed of a material containing a radiation-curable monomer or oligomer.

When the coating film is formed of a material containing a radiation-curable monomer or oligomer, the presently disclosed subject matter is greatly effective.

In order to achieve the above-mentioned object, the functional film of the presently disclosed subject matter is a functional film manufactured by the manufacturing method described above.

In a function film manufactured by the manufacturing method of the presently disclosed subject matter, faults such as cracks and peel-off of an inorganic film are reduced, and thus the functional film can be suitably used as various functional films for use in optical elements, display apparatuses, semiconductor apparatuses, thin film solar cells and the like.

An apparatus for producing a functional film according to an aspect of the presently disclosed subject matter includes a coating film forming apparatus; and a vacuum film forming apparatus, the coating film forming apparatus including: a mechanism for continuously feeding a support from a first film roll; a mechanism for forming a coating film having a degree of hardness of 3B or more on the support; and a mechanism for winding up the support into a second film roll at a tension of 30 N/m or more, and the vacuum film forming apparatus including: a mechanism for continuously feeding the support from the second film roll which has been wound up by the coating film forming apparatus; a mechanism for forming an inorganic film on the coating film formed on the support; and a mechanism for winding up the support into a third film roll.

According to the presently disclosed subject matter, it is possible to provide a functional film, a method for manufacturing the functional film, and an apparatus for manufacturing the functional film capable of reducing the occurrence of faults such as cracks and peel-off of an inorganic film due to impairment of the smoothness of a coating film when an inorganic film is formed on the coating film by a vacuum film forming method.

### BRIEF DESCRIPTION OF THE DRAWINGS

FIG. 1 is a diagram for illustrating a functional film manufactured by a method for manufacturing a functional film according to the presently disclosed subject matter;

FIGS. 2A and 2B are diagrams for illustrating an example of an apparatus for implementing a method for manufacturing a functional film according to the presently disclosed subject matter; and

FIG. 3 is a diagram for illustrating a preferred embodiment of a mechanism for winding a film roll.

### DETAILED DESCRIPTION OF THE PREFERRED EMBODIMENTS

Hereinafter, preferred embodiments of the presently disclosed subject matter will be described according to the drawings. The presently disclosed subject matter will be described through the following preferred embodiments, many modifications can be made without departing from the scope of the presently disclosed subject matter and other embodiments other than the above embodiments can be used. Accordingly, all modifications within the scope of the presently disclosed subject matter are included within the spirit and scope of the appended claims. Also, a numerical range designated as “A to B” means being more than or equal to A and less than or equal to B in the presently disclosed subject matter.

The following describes a method for manufacturing a functional film of the presently disclosed subject matter.

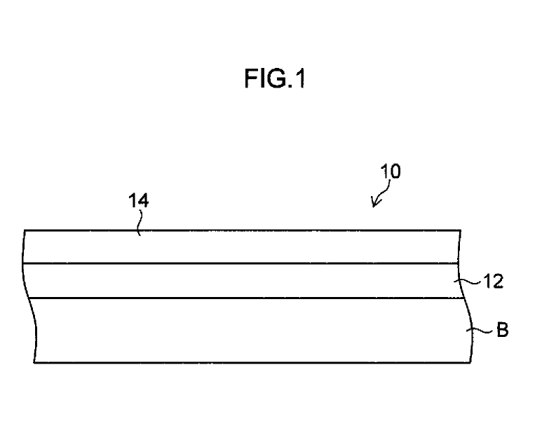

FIG. 1 illustrates a conceptual diagram of a functional film manufactured by a method for manufacturing a functional film of the presently disclosed subject matter.

As illustrated in FIG. 1, in the method for manufacturing a functional film, a predetermined coating film 12 is formed on a surface of a support B (raw fabric film), and an inorganic film 14 is formed on the coating film 12 by a vacuum film forming method to manufacture a laminate 10 (hereinbelow, otherwise referred to as a functional film, laminated film or optical film).

By way of an example, the method for manufacturing a functional film is a method in which a laminated film 10 is manufactured by a coating film forming apparatus 20 which forms a coating film 12 on a surface of the support B and by a vacuum film forming apparatus 22 which forms an inorganic film 14 on a surface of the coating film 12.

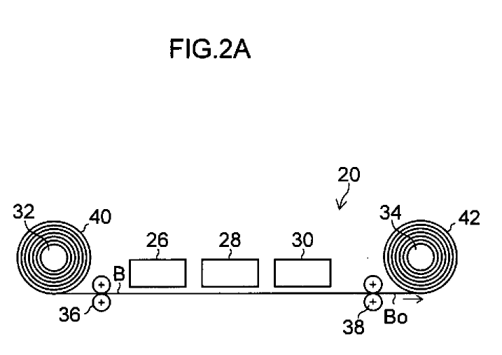

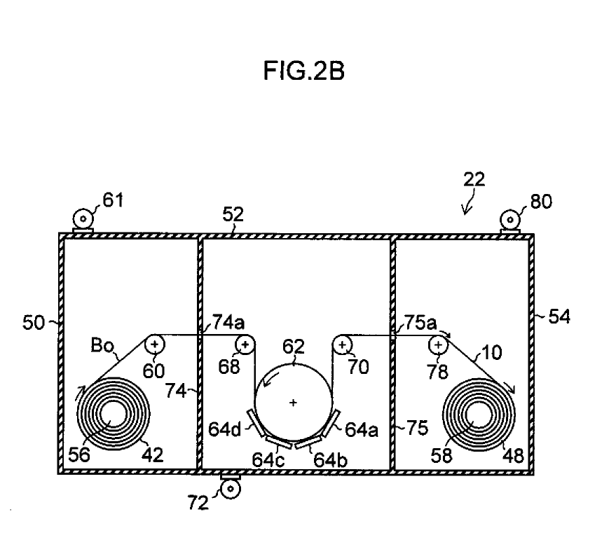

FIG. 2A conceptually illustrates an example of the coating film forming apparatus 20 for implementing the method for manufacturing a functional film.

The coating film forming apparatus 20 includes a coating device 26, a heating device 28 and a UV (ultraviolet) irradiation device 30, in which a previously prepared coating liquid containing a radiation-curable monomer or a radiation-curable oligomer is applied onto a support B by the coating device 26, dried by the heating device 28 and polymerized by the UV irradiation device 30, thereby forming a coating film 12.

This coating film forming apparatus 20 forms a coating film by a roll-to-roll process. A support B is loaded, as a film roll 40, on a rotating shaft 32, and a coating film is formed on the support B while the support B is conveyed in a longitudinal direction thereof. A support Bo on which the coating film has been formed is wound up as a film roll 42 by a wind-up shaft 34.

The support B fed from the film roll 40 is first conveyed to the coating device 26. In the coating device 26, a previously prepared coating liquid containing the radiation-curable monomer or oligomer, which will become the coating film 12, is applied to a surface of the support B. For the application of the coating liquid, any ordinary liquid coating methods can be employed.

The support B is next conveyed to the heating device 28. In the heating device 28, a solvent in the coating liquid that has been applied by the coating device 26 is dried before the support B reaches the UV irradiation device 30. The heating method of the coating liquid is not particularly limited, and any known heating devices, such as heating by a heater and heating by hot air flow, can be employed, as long as the coating liquid can be heated in accordance with the conveying speed of the support B, before the support B reaches the UV irradiation device 30.

The support B is next conveyed to the UV irradiation device 30. In the UV irradiation device 30, the coating liquid that has been applied by the coating device 26 and heated and dried by the heating device 28 is irradiated with ultraviolet rays so as to polymerize the radiation-curable monomer or oligomer, thereby forming the coating film 12.

In the presently disclosed subject matter, the coating film is formed so as to have a degree of hardness of 3B or more. The degree of hardness of the coating film is adjusted so that the pencil hardness thereof is 3B or more by controlling the exposure dose of ultraviolet ray through varying the intensity of illumination or the conveying speed. Here, the pencil hardness is defined by the Japanese Industrial Standards, no. JIS S 6006.

Further, in the presently disclosed subject matter, the support Bo is wound up as a film roll 42 at a tension of 30 N/m or more.

Even when a film roll 42 obtained by coating, drying, and curing a coating film having a degree of hardness of 3B or more and winding at a tension of 30 N/m or more is set in the after-mentioned vacuum film forming apparatus 22, the resulting coating film will not suffer damage, and thus it is possible to reduce the occurrence of faults such as cracks and peel-off of an inorganic film.

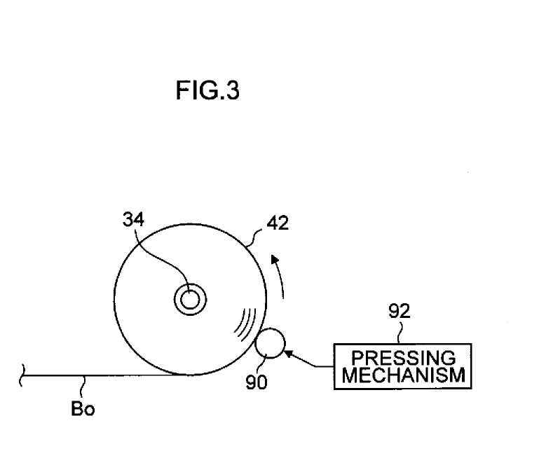

FIG. 3 is a schematic diagram illustrating a preferred mechanism for winding up a film roll according to the presently disclosed subject matter.

A roll core is set at the wind-up shaft 34 and is driven to rotate by a motor (not illustrated). Then, the support Bo is wound up to become the film roll 42.

In the mechanism illustrated in FIG. 3, a lay-on roller 90 is rotatably mounted so as to rotate in contact with the film roll 42. This lay-on roller 90 is adapted to press the support Bo toward the roll core by a pressing mechanism 92. With this configuration, it is possible to remove air entrained with the support Bo during winding the support Bo and to form a film roll 42 where air trapped between the surfaces of the support Bo is removed.

That is, by using the lay-on roller, entrained air generated during winding the support Bo can be reduced, and thus even when a film roll of the support having a coating film formed thereon is loaded in a vacuum film forming apparatus, it is possible to reduce the occurrence of tight winding of the coating film.

Next, the film roll 42 obtained by winding the support Bo having the coating film 12 formed thereon is loaded in a vacuum film forming apparatus 22 as conceptually illustrated in FIG. 2B.

The vacuum film forming apparatus 22 forms an inorganic film 14 on a surface of the support Bo (i.e., a surface of the coating film 12) by a vacuum film forming method. The vacuum film forming apparatus 22 includes a supply chamber 50, a film formation chamber 52, and a wind-up chamber 54.

Similarly to the coating film forming apparatus 20, the vacuum film forming apparatus 22 is also an apparatus that forms a film by a roll-to-roll process. In the vacuum film forming apparatus 22, the support Bo is fed from the film roll 42, and an inorganic film 14 is formed on the support Bo while the support Bo is conveyed in a longitudinal direction. A functional film 10 on which the coating film 12 and the inorganic film 14 have been formed is wound up in the form of a roll by a wind-up shaft 58.

The supply chamber 50 includes a rotating shaft 56, a guide roller (path roller) 60 and a vacuum evacuation device 61.

In the vacuum film forming apparatus 22, the film roll 42 obtained by winding the support Bo, in which the coating film 12 has been formed on the support B, is loaded on a rotating shaft 56 in the supply chamber 50. When film roll 42 is loaded on the rotating shaft 56, the support Bo is passed along a predetermined conveying path from the supply chamber 50, via the film formation chamber 52, to the wind-up shaft 58 in the wind-up chamber 54. Also, in the vacuum film forming apparatus 22, feeding of the support Bo from the film roll 42 is performed in synchronization with winding the functional film 10 by the rotating shaft 56, and while the lengthy support Bo is conveyed in its longitudinal direction in the predetermined conveying path, film formation of the inorganic film 14 is continuously performed on the support Bo.

In the supply chamber 50, the rotating shaft 56 is driven to rotate in a clockwise direction in the figure by a drive source (not illustrated), whereby the support Bo is fed from the film roll 42, guided along the predetermined path by a guide roller (path roller) 60, and fed to the film formation chamber 52.

Meanwhile, on the supply chamber 50, the vacuum evacuation device 61 is placed, and the pressure inside the supply chamber 50 is reduced to a predetermined degree of vacuum (pressure) according to the film formation pressure in the film formation chamber 52, thereby preventing the pressure in the supply chamber 50 from adversely affecting the pressure in the film formation chamber 52 and the film formation. Note that as the vacuum evacuation device 61, a known vacuum evacuation device can be used, similarly to the after-mentioned vacuum evacuation device 72 which is placed at the film formation chamber 52.

Further, the supply chamber 50 may include, in addition to the illustrated members, various members (conveying devices) for conveying the support Bo along the predetermined path, such as a pair of conveying rollers, and guide members for regulating a position of the support Bo in a cross-machine direction.

The support Bo is guided by the guide roller 60 and conveyed to the film formation chamber 52.

The film formation chamber 52 is provided for forming the inorganic film 14 on a surface of the support Bo (i.e., on a surface of the coating film 12) by a vacuum film forming method. In the illustrated example, the film formation chamber 52 includes a drum 62, film forming devices 64a, 64b, 64c, and 64d, guide rollers 68 and 70, and a vacuum evacuation device 72. Note that when the film formation chamber 52 is the one where film formation is performed by sputtering, plasma CVD or the like, a high-frequency power source and the like are further provided in the film formation chamber 52.

The support Bo is conveyed to the film formation chamber 52 from a slit 74a formed in a partition wall 74 which separates the supply chamber 50 from the film formation chamber 52.

Notably, in the illustrated example of the vacuum film forming apparatus 22, a vacuum evacuation device is preferably provided in the supply chamber 50 as well as in the wind-up chamber 54, and the inside of the supply chamber 50 and the wind-up chamber 54 are also evacuated to a vacuum state in accordance with the film formation pressure at the film formation chamber 52. The apparatus for implementing the presently disclosed subject matter is not limited to the illustrated example. For example, the apparatus may be configured so that no vacuum evacuation device is provided in the supply chamber 50 and in the wind-up chamber 54, and the slits through which the support Bo passes may be formed to have such a minimum size that the support Bo can pass through without contacting the support Bo, whereby the film formation chamber 52 is configured to be substantially airtight. Alternatively, the apparatus may be configured so that no vacuum evacuation device is provided in the supply chamber 50 and in the wind-up chamber 54, and a sub-chamber through which the support Bo passes is provided between the supply chamber 50 and film formation chamber 52, and between the film formation chamber 52 and the wind-up chamber 54, the inside of each of the sub-chambers may be vacuumized by a vacuum pump.

Note that when a sub-chamber or the like is provided upstream the film formation chamber 52 (upstream in the conveyance direction of the support Bo), it is required that a device for conveying the base material inside the sub-chamber, if the device comes into contact with the coating film 12, be also configured to be in contact with only the ends of the support Bo.

The drum 62 in the film formation chamber 52 is a cylindrical member which rotates in a counterclockwise direction in the figure, on the basis of the center line thereof.

The support Bo supplied from the supply chamber 50 and guided to the predetermined path by the guide roller (path roller) 68 is spooled over the drum 62 and is conveyed along the predetermined conveyance path while being supported and guided by the drum 62, and then the inorganic film 14 is formed on its surface (on the coating film 12) by the film forming devices 64a to 64d and the like. When in the film formation chamber 52, film formation is performed by sputtering, plasma CVD or the like, the drum 62 may be grounded (earthed) or connected to a high-frequency power source so as to function as a counter-electrode.

The film forming devices 64a to 64d are provided for forming the inorganic film 14 over the surface of the support B by a vacuum film forming method.

Here, in the manufacturing method of the presently disclosed subject matter, the forming method of the inorganic film 14 is not particularly limited, and any known vacuum film forming methods (vapor-phase deposition methods) such as CVD, plasma CVD, sputtering, vacuum deposition, and ion-plating can be employed.

Thus, the film forming devices 64a to 64d are composed of various members suitable for the vacuum film forming method implemented.

For example, when the film formation chamber 52 is the one where the inorganic film 14 is formed by an ICP-CVD method (Inductively-Coupled Plasma CVD), the film forming devices 64a to 64d can include an induction coil for forming an induction magnetic field, and a gas supply device for supplying a film formation area with a reactive gas.

When the film formation chamber 52 is the one where the inorganic film 14 is formed by a CCP-CVD method (Capacitively-Coupled Plasma CVD), the film forming devices 64a to 64d can include a shower electrode which is a hollow shaped member having a number of micro pores at the surface facing the drum 62 and functions as a high-frequency electrode and a reactive gas supplying device to be connected to a reactive gas supply source.

When the film formation chamber 52 is the one where the inorganic film 14 is formed by a CVD method, the film forming devices 64a to 64d can include a device for introducing a reactive gas.

In addition, when the film formation chamber 52 is the one where the inorganic film 14 is formed by sputtering, the film forming devices 64a to 64d can include a device for holding a target, a high-frequency electrode, and a device for supplying a sputtering gas.

The vacuum evacuation device 72 evaluates the film formation chamber 52 to a degree of vacuum adequate for the formation of the inorganic film 14 by a vacuum film forming method.

The vacuum evacuation device 72 is not also particularly limited. A known (vacuum) evacuation device which is employed in a vacuum film forming apparatus can be used as the vacuum evacuation device 72. The known (vacuum) evacuation device can be a vacuum pump such as a turbo pump, a mechanical booster pump and a rotary pump. The known (vacuum) evacuation device can include a device which uses an auxiliary device such as cryocoil, and a device for adjusting the ultimate degree of vacuum or the discharge air amount.

While being supported and conveyed by the drum 62, the support Bo having on its surface the inorganic film 14 formed by the film forming devices 64a to 64d, that is, the functional film 10 is guided to a predetermined path by the guide roller 70, conveyed to the wind-up chamber 54 and wound up in the form of a roll by the wind-up shaft 58. The laminated film (functional film) roll wound up in the form of a roll is then subjected to the subsequent step.

As described above, the method for manufacturing a functional film of the presently disclosed subject matter includes the steps of: continuously feeding a support B from a film roll 40, forming, on the support B, a coating film 12 having a degree of hardness of 3B (indicated by the pencil hardness) or more, and winding up the support B into a film roll 42 at a tension of 30 N/m or more; and loading the film roll 42 which has been wound up in the prior step in a vacuum film forming apparatus 22, continuously feeding the support Bo from the film roll 42, forming an inorganic film 14 on the coating film 12 formed on the support Bo, and winding up the support Bo into a film roll.

According to a conventional method for manufacturing a functional film, when a film roll 42 entrained with air is set in a feeding unit in a depressurized vacuum film forming apparatus 22, the entrained air in the film roll comes out of the film roll, whereby the balance of stress (tension, frictional force) inside the film roll is disrupted while the stress is balanced during winding the functional film, causing “tight winding” of the film roll. Then, the inventors of the presently disclosed subject matter found that when the “tight winding” occurs, in the film roll, a coating film formed on a support comes into contact with a back surface of the support present in its upper position, microscopic film rupture occurs in the coating film, resulting in a lost of smoothness of the film. Thereafter, when the support is conveyed and an inorganic film is formed on the coating film, a film-forming fault occurs to cause cracks and peel-off of the inorganic film.

Then, the inventors of the presently disclosed subject matter have derived optimum conditions for the degree of hardness of the coating film and the tension applied to the support during winding the support. And, the present inventors of the presently disclosed subject matter have found that it is important to wind the support under the optimum conditions.

According to the presently disclosed subject matter, even when a film roll which is obtained by coating, drying and curing a coating film having a degree of hardness of 3B (pencil hardness) or more and then winding at a tension of 30 N/m or more is set in a vacuum film forming apparatus, the coating film will not suffer damage. Therefore, according to the presently disclosed subject matter, it is possible to provide a method for manufacturing a functional film capable of reducing the occurrence of faults such as cracks and peel-off of an inorganic film.

Note that the degree of hardness of the coating film is more preferably 3B to 3H (pencil hardness) and the tension at which the coating film is wound up on the film roll is more preferably 30 N/m to 500 N/m.

Meanwhile, in the presently disclosed subject matter, the thickness of the inorganic film 14 formed is preferably 10 nm or more. More specifically, the thickness of the inorganic film is more preferably 10 nm to 200 nm.

By the method for manufacturing a functional film of the presently disclosed subject matter, it is possible to reduce the occurrence of faults such as cracks and peel-off of an inorganic film. Thus, the presently disclosed subject matter can provide a high-yield method for manufacturing a functional film.

The coating film 12 preferably has a smooth surface and a high degree of film hardness. The smoothness of the coating film 12 is, as a surface roughness (Ra value) in an area of 10-μm square, preferably 10 nm or less, more preferably 2 nm or less.

In the presently disclosed subject matter, the support B over which the coating film 12 and inorganic film 14 will be formed is not particularly limited. Any various base materials (base films) used for various types of functional films such as a gas barrier film, an optical film and a protective film, can be used as the support B, as long as the base materials are the after-mentioned materials capable of forming the coating film 12 and forming the inorganic film 14 through vacuum film forming. For example, various types of resin films such as PET (polyethylene terephthalate) film, and various types of metal sheets such as aluminum sheet can be used as the support B.

Further, the support B may be the one having, on its surface, various types of formed films such as a protective film and an adhesive film.

The coating film 12 can contain, as the main component, a radiation-curable monomer or a radiation-curable oligomer. More specifically, as the monomer or oligomer to be used, preferred are monomers or oligomers which have two or more ethylenically unsaturated double bonds and which are addition polymerizable by irradiation with light. As such monomers or oligomers, there may be exemplified a compound having at least one addition-polymerizable ethylenically unsaturated group in the molecule and having a boiling point of 100° C. or higher under normal pressure. Specific examples thereof include monofunctional acrylates and monofunctional methacrylates such as polyethylene glycol mono(meth)acrylate, polypropylene glycol mono(meth)acrylate, and phenoxyethyl(meth)acrylate; polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl) ether, tri(acryloyloxyethyl) isocyanurate, tri(acryloyloxyethyl) cyanurate, and glycerin tri(meth)acrylate; and polyfunctional acrylates and polyfunctional methacrylates, for example, those obtained by addition of an ethylene oxide or propylene oxide on a polyfunctional alcohol, such as trimethylolpropane and glycerin, followed by subjecting to (meth)acrylation.

In addition to the above, there may be exemplified urethane acrylates described in Japanese Examined Application Publication Nos. 48-41708, 50-6034 and Japanese Patent Application Laid-Open No. 51-37193; polyester acrylates described in Japanese Patent Application Laid-Open No. 48-64183, Japanese Examined Application Publication Nos. 49-43191 and 52-30490; and polyfunctional acrylates and methacrylates such as epoxy acrylates, which are reaction products between an epoxy resin and a (meth)acrylic acid.

Among these, preferred are trimethylolpropane tri(meth)acrylate, pentaerythritol tetra(meth)acrylate, dipentaerythritol hexa(meth)acrylate, and dipentaerythritol penta(meth)acrylate.

Besides the above, as preferred examples thereof, “polymerizable compound B” described in Japanese Patent Application Laid-Open No. 11-133600 may be exemplified as well.

As a photopolymerization initiator or photopolymerization initiator system to be used, there may be exemplified a vicinal polyketaldonyl compound disclosed in U.S. Pat. No. 2,367,660, an acyloin ether compound described in U.S. Pat. No. 2,448,828, an aromatic acyloin compound substituted with α-hydrocarbon described in U.S. Pat. No. 2,722,512, a polynuclear quinone compound described in U.S. Pat. Nos. 3,046,127 and 2,951,758, a combination of a triarylimidazole dimer and p-aminoketone described in U.S. Pat. No. 3,549,367, a benzothiazole compound and a trihalomethyl-s-triazine compound described in Japanese Examined Application Publication No. 51-48516, a trihalomethyl-triazine compound described in U.S. Pat. No. 4,239,850, and a trihalomethyloxadiazole compound described in U.S. Pat. No. 4,212,976. Particularly, trihalomethyl-s-triazine, trihalomethyloxadiazole, and triarylimidazole dimer are preferred.

Additionally, preferred examples thereof include a “polymerization initiator C” described in Japanese Patent Application Laid-Open No. 11-133600. The amount of the photopolymerization initiator used is preferably 0.01% by mass to 20% by mass, more preferably 0.5% by mass to 10% by mass relative to the solid content of the coating liquid. As for the irradiation of light for the polymerization of a liquid crystal compound, it is preferred to use ultraviolet ray. The radiation energy of the ultraviolet ray is preferably 20 mJ/cm² to 50 J/cm², more preferably 100 mJ/cm² to 2,000 mJ/cm². In order to accelerate the photopolymerization reaction, the irradiation of light may be performed under heating conditions.

Examples of the forming method of the coating film 12 include a usual solution coating method, or a vacuum film forming method.

As the solution coating method, the coating liquid can be applied by using, for instance, a dip coating method, an air knife coating method, a curtain coating method, a roller coating method, a wire-bar coating method, a gravure coating method, a slide coating method, or an extrusion coating method using a hopper described in U.S. Pat. No. 2,681,294.

Note that acrylate and methacrylate suffer from polymerization inhibition due to oxygen in air. For this reason, in the presently disclosed subject matter, when acrylate and/or methacrylate are used as the coating film 12, it is preferable to reduce the oxygen concentration or the oxygen partial pressure during the polymerization. When the oxygen concentration during the polymerization is reduced by nitrogen substitution, the oxygen concentration is preferably 2% or less, more preferably 0.5% or less. When the oxygen partial pressure during the polymerization is reduced by depressurization, the total pressure is preferably 1,000 Pa or less, more preferably 100 Pa or less. It is particularly preferred to perform the polymerization by irradiating with ultraviolet ray under the conditions of a reduced pressure of 100 Pa or less and a radiation energy of 2 J/cm² or more.

In the presently disclosed subject matter, the degree of polymerization of the monomer is preferably 80% or more, more preferably 85% or more, still more preferably 90% or more. The degree of polymerization mentioned here means a ratio of the reacted polymerizable groups to all the polymerizable groups (for example, in the case of using acrylate and/or methacrylate, acryloyl groups and/or methacryloyl groups) in the monomer mixture.

When as a laminated film (functional film), a protective film for various devices and systems, such as display apparatuses like an organic EL display apparatus and a liquid crystal display apparatus, is manufactured, a silicon oxide film may be formed as the inorganic film 14.

Further, when an optical film such as an anti-reflection film, a light reflection film or various filters is manufactured, a film made of a material having or exhibiting intended optical properties may be formed as an inorganic film 14.

Among these films, the manufacturing method of the presently disclosed subject matter is most suitable for manufacturing a gas barrier film because an inorganic film 14 excellent in gas barrier property can be formed owing to its excellent surface smoothness of the coating film 12.

In lamination process, i.e., when a coating film is further formed on the inorganic film, “tight winding” and “handling damage” can occur, and thus the effects of the presently disclosed subject matter are greatly exhibited.

Hereinabove, a functional film, a method for manufacturing the functional film, and an apparatus for manufacturing the functional film according to the presently disclosed subject matter have been described in detail through the embodiments, which however shall not be construed as limiting the scope of the presently disclosed subject matter. Accordingly various modifications and equivalent arrangements may be made without deviating from the spirit and scope of the presently disclosed subject matter.

### EXAMPLES

Hereinafter, the presently disclosed subject matter will be further described in detail with reference to certain specific examples of the presently disclosed subject matter.

### Example 1

A functional film was manufactured using a coating film forming apparatus 20 and a vacuum film forming apparatus 22 illustrated in FIG. 2.

The coating film 12 was formed in the following manner. An acrylic monomer and a photopolymerization initiator were dissolved in an organic solvent to prepare a coating solution, and the coating solution was applied to a support B by a die coater, dried and then cured by ultraviolet curing to form a coating film. The thickness of the coating film was controlled with a liquid feeding rate so that the coating film had a thickness of 1 μm in a completely cured state. The degree of hardness of the coating film was adjusted by controlling the exposure dose of ultraviolet ray through varying the intensity of illumination or the conveying speed, thereby providing a desired film hardness (pencil hardness) described in Table 1.

As the support B, a PET base of 1,000 mm in width and 100 μm in thickness was used.

In a winder used, the winding-up tension was controlled so as to be constant at a value described in Table 1, depending on the winding diameter.

As an inorganic film 14, an alumina film was formed by reactive sputtering using aluminum as a target, thereby obtaining a functional film 10 having a desired thickness described in Table 1.

The thus manufactured functional film 10 was subjected to an evaluation for the water vapor permeability performance according to the following evaluation criteria.

### [Evaluation Criteria of Performance (Water Vapor Permeability)]

D: 1.0×10⁻³ g/m²·day or more
C: 2.0×10⁻⁴ g/m²·day or more and less than 1.0×10⁻³ g/m²·day
B: 1.0×10⁻⁴ g/m²·day or more and less than 2.0×10⁻⁴ g/m²·day
A: less than 1.0×10⁻⁴ g/m²·day

TABLE 1

| | | Degree of | | | |
|---|---|---|---|---|---|
| | | hardness of | | | |
| | Winding-up | organic film | Thickness | Water vapor | |
| | tension | (pencil | of inorganic | permeability | Evaluation of |
| Experiment | (N/m) | hardness) | film (nm) | (g/m² · day) | performance |
| 1 | 30 | 4B | 60 | 3.4 × 10⁻³ | D |
| 2 | 150 | 4B | 60 | 3.1 × 10⁻³ | D |
| 3 | 500 | 4B | 60 | 1.8 × 10⁻³ | D |
| 4 | 10 | 3B | 60 | 2.8 × 10⁻³ | D |
| 5 | 30 | 3B | 60 | 3.7 × 10⁻⁴ | C |
| 6 | 150 | 3B | 60 | 1.9 × 10⁻⁴ | B |
| 7 | 500 | 3B | 60 | 1.7 × 10⁻⁴ | B |
| 8 | 150 | B | 60 | 1.4 × 10⁻⁴ | B |
| 9 | 150 | H | 60 | 9.5 × 10⁻⁵ | A |
| 10 | 150 | 3H | 60 | 8.9 × 10⁻⁵ | A |
| 11 | 150 | 3B | 10 | 3.2 × 10⁻⁴ | C |
| 12 | 150 | 3B | 200 | 1.2 × 10⁻⁴ | B |

As understood from Table 1, the functional film, which has been manufactured so that the degree of hardness of a coating film is 3B (pencil hardness) or more and the winding-up tension is kept at 30 N/m or more, can be improved in the performance of water vapor permeability. Consequently, the occurrence of faults such as cracks and peel-off of an inorganic film can be reduced by the presently disclosed subject matter.

### Example 2

A functional film was manufactured using a coating film forming apparatus 20 and a vacuum film forming apparatus 22 illustrated in FIG. 2.

As material of the coating film 12, a coating liquid was prepared in which VYLON 245 (2 parts) was dissolved in MEK (methyl ethyl ketone) (40 parts) and cyclohexanone (60 parts). Here, VYLON is a registered trademark in Japan, and VYLON 245 is a product (a kind of amorphous polyester resin (organic solvent fusible type)) of Toyobo Co., Ltd.

As a support B, a PEN (polyethylene naphthalate) film of 1,000 mm in width and 100 μm in thickness was used. The prepared coating liquid was applied onto the PEN film by a bar coater, and dried, to thereby form a coating film on the PEN film.

In a wind-up chamber, the PEN film was wound up into a film roll by a wind-up shaft so that the winding-up tension was kept constant (150 N/m) depending on the winding diameter.

In a winder used, the winding-up tension was controlled so as to be constant at a value described in Table 2, depending on the winding diameter.

As an inorganic film 14, a SiO film was formed by reactive sputtering, thereby obtaining a functional film 10 having a desired thickness described in Table 2.

The thus manufactured functional film 10 was subjected to an evaluation for the water vapor permeability performance according to the following evaluation criteria.

### [Evaluation Criteria of Performance (Water Vapor Permeability)]

D: 1.0×10⁻¹ g/m²·day or more
C: 2.0×10⁻² g/m²·day or more and less than 1.0×10⁻¹ g/m²·day
B: 1.0×10⁻² g/m²·day or more and less than 2.0×10⁻² g/m²·day
A: less than 1.0×10⁻² g/m²·day

TABLE 2

| | | Degree of | | | |
|---|---|---|---|---|---|
| | | hardness of | | | |
| | Winding-up | organic film | Thickness | Water vapor | |
| | tension | (pencil | of inorganic | permeability | Evaluation of |
| Experiment | (N/m) | hardness) | film (nm) | (g/m² · day) | performance |
| 13 | 10 | 3B | 60 | 4.8 × 10⁻¹ | D |
| 14 | 30 | 3B | 60 | 3.2 × 10⁻² | C |
| 15 | 150 | 3B | 60 | 1.8 × 10⁻² | B |
| 16 | 500 | 3B | 60 | 1.4 × 10⁻² | B |

As understood from Table 2, the functional film, which has been manufactured so that the degree of hardness of the coating film is 3B or more and the winding-up tension is kept at 30 N/m or more, is improved in the performance of water vapor permeability. Consequently, the occurrence of faults such as cracks and peel-off of an inorganic film can be reduced by the presently disclosed subject matter.

### Example 3

Further, a film roll 42 was wound up using a lay-on roller 90 illustrated in FIG. 3 under the conditions of Experiments 1 to 7 shown in Table 1. That is, the film roll 42 was wound up in a state of being nipped by a lay-on roller 90. In this case, the winding-up tension was controlled together with the touch pressure of the lay-on roller 90. Note that the touch pressure of the lay-on roller 90 was applied so that it was 10 N/m to 100 N/m.

The functional film 10 manufactured using the lay-on roller 90 was subjected to an evaluation for the water vapor permeability performance according to the same evaluation criteria in Example 1.

TABLE 3

| | | | Degree of | | | |
|---|---|---|---|---|---|---|
| | | | hardness of | | | |
| | Winding-up | | organic film | Thickness | Water vapor | |
| | tension | Lay-on | (pencil | of inorganic | permeability | Evaluation of |
| Experiment | (N/m) | roller | hardness) | film (nm) | (g/m² · day) | performance |
| 17 | 30 | Provided | 4B | 60 | 2.1 × 10⁻³ | D |
| 18 | 150 | Provided | 4B | 60 | 2.0 × 10⁻³ | D |
| 19 | 500 | Provided | 4B | 60 | 1.5 × 10⁻³ | D |
| 20 | 10 | Provided | 3B | 60 | 2.5 × 10⁻³ | D |
| 21 | 30 | Provided | 3B | 60 | 1.8 × 10⁻⁴ | B |
| 22 | 150 | Provided | 3B | 60 | 9.5 × 10⁻⁵ | A |
| 23 | 500 | Provided | 3B | 60 | 8.7 × 10⁻⁵ | A |

From the comparison between Experiments 1 to 7 and Experiments 17 to 23, as for the functional film, which has been manufactured so that the degree of hardness of the coating film is 3B or more and the winding-up tension is kept at 30 N/m or more, the performance of water vapor permeability of the manufactured functional film can be improved by using a lay-on roller during winding-up a film roll by a coating film forming apparatus.

What is claimed is:

1. A method for manufacturing a functional film, comprising the steps of:
continuously feeding a support from a first film roll, forming, on the support, a coating film having a degree of hardness of 3B or more, and winding up the support into a second film roll at a tension of 30 N/m or more; and
loading the second film roll which has been wound up in the prior step in a vacuum film forming apparatus, continuously feeding the support from the second film roll, forming an inorganic film on the coating film formed on the support, and winding up the support into a third film roll.

2. The method for manufacturing a functional film according to claim 1, wherein the support having the coating film formed thereon is wound up into the second film roll by using a lay-on roller.

3. The method for manufacturing a functional film according to claim 1, wherein the thickness of the inorganic film formed is 10 nm or more.

4. The method for manufacturing a functional film according to claim 1, wherein the coating film is formed of a material comprising a radiation-curable monomer or oligomer.

5. A functional film, manufactured by the method according to claim 1.

6. An apparatus for manufacturing a functional film, comprising:
a coating film forming apparatus; and
a vacuum film forming apparatus,
the coating film forming apparatus comprising:
a mechanism for continuously feeding a support from a first film roll;
a mechanism for forming a coating film having a degree of hardness of 3B or more on the support; and
a mechanism for winding up the support into a second film roll at a tension of 30 N/m or more, and
the vacuum film forming apparatus comprising:
a mechanism for continuously feeding the support from the second film roll which has been wound up by the coating film forming apparatus;
a mechanism for forming an inorganic film on the coating film formed on the support; and
a mechanism for winding up the support into a third film roll.
